(19) United States
(12) Patent Application Publication
(10) Pub. No.: US 2007/0150314 A1
(43) Pub. Date: Jun. 28, 2007

(54) Method for carrying out quality control of medical data records collected from different but comparable patient collectives within the bounds of a medical plan

(76) Inventors: Klaus Abraham-Fuchs, Erlangen (DE); Rainer Kuth, Herzogenaurach (DE); Eva Rumpel, Erlangen (DE); Markus Schmidt, Nurnberg (DE); Siegfried Schneider, Erlangen (DE); Horst Schreiner, Furth (DE); Gudrun Zahlmann, Neumarkt (DE)

Correspondence Address: HARNESS, DICKEY & PIERCE, P.L.C., P.O.BOX 8910, RESTON, VA, 20195, US

(21) Appl. No.: 10/589,559

(22) PCT Filed: Feb. 7, 2005
(86) PCT No.: PCT/EP05/50502

§ 371 Date: Aug. 16, 2006

(30) Foreign Application Priority Data
Feb. 18, 2004 (DE) 10 2004 008 197.2
Oct. 28, 2004 (DE) 10 2004 052 564.3

(51) Int. Cl. G06F 19/00

(52) U.S. Cl. 705/3

(57) ABSTRACT

A method is disclosed for carrying out quality control of medical data records collected from different but comparable patient collectives within the bounds of a medical plan. In the method, for each data record, a quality control parameter assigned thereto is determined in the same manner. Further, the quality control parameters are evaluated using comparison criteria.

### PRIORITY STATEMENT

This application is the national phase under 35 U.S.C. §371 of PCT International Application No. PCT/EP2005/050502 which has an International filing date of Feb. 7, 2005, which designated the United States of America and which claims priority on German Patent Applications number DE 10 2004 008 197.2 filed Feb. 18, 2004, and number DE 10 2004 052 546.3 filed Oct. 28, 2004, the entire contents of each of which are hereby incorporated herein by reference.

### FIELD

The invention generally relates to a method for carrying out quality control of medical data records collected from different but comparable patient collectives during a medical project.

### BACKGROUND

Medical projects are initiated by pharmaceutical companies, research institutes, government bodies or other organizations involved in healthcare in the form of studies, outcome analyses, technology assessments or clinical trials in order to test new medicines, treatment methods or medical procedures on patients. The number of patients participating in such projects may range from a few individuals through to many thousands. The medical projects are intended to determine, for example, the effectiveness, benefits or risks of the subject of the test, or to obtain its official approval by a government body.

A large volume of data is collected during such projects. This covers the entire spectrum of clinical medical data from textual data (patient questionnaires, protocols, diagnoses) and measurement data (blood pressure, pulse rate, blood test results) through to imaging data (X-rays, NMR). To obtain the optimal objective and comparable data during a medical project, the medical project is subject to procedural rules which govern the data collection in varying degrees of detail. In the case of clinical trials, these could be, for example, study protocols worked out down to the very last detail, whereas in the case of a promotional project, they could be freely chosen rules.

The data is usually collected by various investigators, such as clinics, research institutes or medical practices. Ideally the data is collected from all patients in the same manner by all investigators in accordance with the procedural rules, and the patients have all the same characteristics with respect to the project (for instance, in a study about leg fractures, it is irrelevant whether the patient wears spectacles or not).

However, variances in the data collection do occur, already simply by virtue of the different investigators, or their geographically different location, different people running or responsible for the project, different measurement equipment etc. Moreover, procedural rules often allow some leeway in determining the data. An experienced specialist will always determine data of a higher quality than a beginner. The relevant medical data is also often deliberately falsified in order to gain particular advantages, or patients that are unsuitable according to the study protocol are knowingly registered for a clinical trial.

If all the patients participating in one and the same project are divided into different patient collectives which are, for example, each assigned to one investigator or to one responsible person or the like, then the quality of the data associated with each patient collective often varies, i.e. with respect to observance of the protocol, uniformity, statistical scattering, etc.

Checking the data quality by checking every collection process is de facto both impossible and unaffordable. Quality is usually assessed nowadays using subjective criteria or experiential values (e.g.: it is know among pharmaceutical companies that investigator “A” closely follows the protocols during data collection). These days, if at all, at most spot-checks are carried out on collected data records.

Owing to the lack of quality assessment of the collected data, the quality of the investigators themselves cannot be objectively assessed, nor can they be, for example, ranked according to quality, and nor can any success-based remuneration models be used.

### SUMMARY

In at least one embodiment of the present invention, a method is disclosed to improve the quality control for medical data records collected during a medical project.

The method, in at least one embodiment, is for carrying out quality control of medical data records collected from different but comparable patient collectives during a medical project, having the following steps. A quality control parameter assigned to each data record is determined in the same manner. The quality control parameters are evaluated on the basis of comparison criteria.

It is assumed for comparable patient collectives that their key characteristics with respect to the data collection are identical, for example the same age and gender structure, ethnic origin, blood group, disease diagnosis, comorbid conditions and disease stage. Different means that they are composed of different individuals as patients, or are located at different clinics, or supervised by different clinicians.

Virtually all known mathematical/statistical parameters that can be extracted from data records are possible as quality control parameters, such as mean value, scatter, variance, predicted value or trend analysis for example, through to methods of image processing or pattern recognition methods, such as the identification and characterization of spatial clusters in multidimensional data records.

Comparison criteria for evaluating the quality control parameters are, for example, checking for identity, variances, permitted percentage tolerances, observance of prescribed value ranges or the like. The choice of comparison criteria depends on many factors, for example whether something is known about, and if so, what is known about the quality control parameters, whether similar data records have already been collected and checked, or whether it is the first such data collection.

At least one embodiment of the invention includes the following considerations: Especially when collecting large volumes of data, the quality of an individual data item in a medical data record cannot be assessed. Particularly if data is collected across relatively large patient collectives, where the patient collectives are the same in terms of their characteristic composition and the data is collected in the same manner, it can be expected that many statistical variables of the datasets associated with a patient collective in each case should ideally be virtually the same. If relatively large variances are detected therefore, this must be due either to differently composed patient collectives or to different execution, or to circumstances, errors, carelessness or the like during data collection. How big a difference between the statistical variables of individual patient collectives can be tolerated varies from case to case.

Since a quality control parameter is determined in the same manner for every data record associated with a patient collective in each case, if the structure of the patient collectives is actually identical and the data collection is comparable, that is to say if the data records are of the same quality, it can be assumed that the quality control parameters will have approximately the same values.

By evaluating the quality control parameters on the basis of the comparison criteria, it is then possible to decide whether the quality control parameters deviate from one another more than is permissible or not. It is irrelevant here when the quality control parameters were collected, whether directly at the time of comparison, or possibly already much earlier. If no variances are detected, then, on the basis of the same conditions under which the data records were collected, it can also be assumed that, for example, all procedural rules have been followed during data collection for the patient collectives associated with both data records, that no other influences that could affect the data have been left unconsidered, and that the data quality of both data records is high.

If a variance between the quality control parameters is detected, it is not possible to conclude, for example in the case of only two data records, which data record has the better data quality, but rather only to recognize that factors which cause the variance exist. This may be, for example, an aspect that had not been considered in advance, as a result of which the patient collectives differ, or the non-observance or differing observance of rules during the data collection in one patient collective. Further case-specific investigation and consideration are then necessary at this point in order to identify the reasons for the differences and to determine which data record is correct and which was recorded under the wrong conditions.

If there are many patient collectives, it can usually be determined which data records constitute “blips” and are consequently to be considered incorrect or lower in quality. The other data records are then to be regarded as correct and of high quality.

It is thus possible to identify previously unrecognized causal links that lead to systematic differences in data records of different patient collectives. Such differences may be used to select new quality control parameters for a current or future project.

The method can be performed at any time, not just at the end of a project, but also, for example, as a milestone during the initial phase of the project. It is thus possible to perform, for example, an interim analysis of the data collected so far in order to estimate whether the project will be successful or not, to reinforce or correct procedural rules, or to prepare interim reports.

From the quality control parameter assigned to it, it is possible to determine a quality level for every data record on the basis of quality criteria. A quality criterion may be, for example, a nominal value in the form of a value or value range for a quality control parameter. The quality level is then, for example, the variance of the actual value of the quality control parameter from the nominal value. By way of the quality levels determined, it is possible to create a quality sequence for different data records which reflects the quality of the data collection of the relevant data record or of the associated patient collective respectively.

Low-quality data can thus be excluded, for example, from the final evaluation of the project, or it is possible to specify “typical” boundary values, expected values or mean values for quality control parameters for future projects.

Such quality levels can be determined, for example, during a clinical trial shortly after its commencement, on the first 10% of the data records determined, in order if necessary to optimize or change study protocols, study sites, investigators or the like if it emerges that the data quality actually achieved does not meet the desired quality criteria, that is to say the requirements. If the quality level of a particular data record is too low, it can be excluded from further data processing, that is to say from the evaluation of the medical project, and marked as invalid. The quality level may also be used to improve similar medical projects following the one just performed.

Boundary values assigned to the medical project can be specified for the quality control parameters. The quality level of the data records is then determined on the basis of the boundary values. If, for example, X-ray images are collected as medical data records during the medical project, it is possible to use image processing methods to exclude, for example, all X-rays that do not wholly cover the desired region of the patient's body. Only X-ray images that contain said region are categorized as suitable for the trial. It is also possible to specify, for example before a clinical trial commences, that the mean value of a particular blood test result of all patients should lie between certain boundaries. If the mean value deviates from this, this is an indication of incorrectly registered patients or incorrect measuring methods. Another example is the detection of technically impossible noise spectra in data, which would imply artificially generated data. It is thus possible to reveal fraudulently falsified data collections.

The medical data is usually collected by, or the data collection is at least supervised by, project managers. A project manager may be a person, for example a senior clinician responsible for trials in a clinic, or an institution, for example an investigator in the form of a clinic. If the medical data records are collected by project managers, then the quality levels assigned to the data records can be assigned to the project managers. By assigning a quality level to a project manager it is possible, for example, to arrange quality-dependent remuneration of the project manager for the medical project run, or to benchmark project managers, create a database of reliable and less reliable project managers, or exclude low-quality project managers from future projects.

It is possible to specify, for example, specific targets for quality control parameters for project managers or investigators and consequently agree success-based payment. Models are, for example, payment according to fixed rates depending on the quality of the data supplied. Or the best investigator receives the full amount, and all others receive a percentage of the full amount based on the quality level.

The quality levels assigned to the data records may be stored in a database. Together with each quality level, a description associated with it is stored in the database. The description includes here characteristics of the patient collective, the medical project, the collection of the data records, and the determination of the quality control parameters, etc. In addition to the quality level, therefore, information is also available, namely about the methods and circumstances under which it was determined.

This enables the quality levels of the database also to be available as reference values for subsequently collected data records in other patient collectives, since the comparability of the patient collectives and the determination of the quality control parameters can be maintained even if the original data records from which the quality level stored in the database was determined are no longer present. Thus it is possible over the years to build up a database which includes more and more quality relationships between patient collectives, investigators, study sites, project managers etc. A ranking, for example, is thus created for future studies which provides information about the reliability of investigators.

The data records can be determined in the course of a clinical workflow. The clinical workflow is then executed depending on the quality control parameters determined. The quality control parameters can thus be employed as a decision criterion or trigger in an electronic workflow management system. If, for instance, an investigator is excluded as unreliable or fraudulent from a given clinical trial, then this trigger impulse can bar the respective investigator from all other current trials with immediate effect, or initiate the search for a replacement investigator.

The method according to at least one embodiment of the invention can be implemented in a quality management system which then includes, for example, a toolset containing all meaningful mathematical/statistical methods for deriving quality control parameters. The toolset can then be applied to two or more data records of patient collectives. This greatly facilitates the quick and easy evaluation of a past, current or future medical project, or its design.

If the medical data records or the databases of medical projects respectively have a standardized format, then with the aid of an appropriate quality management system it is possible to evaluate and assess every project accessible via databases with a simple mouse click using a suitably adapted standardized interface. As a consequence, no further laborious and time-consuming inputs, formatting or data transfer are then required. Checking can be performed even more quickly and easily.

### BRIEF DESCRIPTION OF THE DRAWINGS

For a further description of the invention, reference is made to the example embodiments in the drawings, in which, in a schematic representation in each case:

FIG. 1 shows the flowchart for the quality control of a clinical trial,

FIG. 2 shows the time curve of the blood pressure of an individual patient.

### DETAILED DESCRIPTION OF THE EXAMPLE EMBODIMENTS

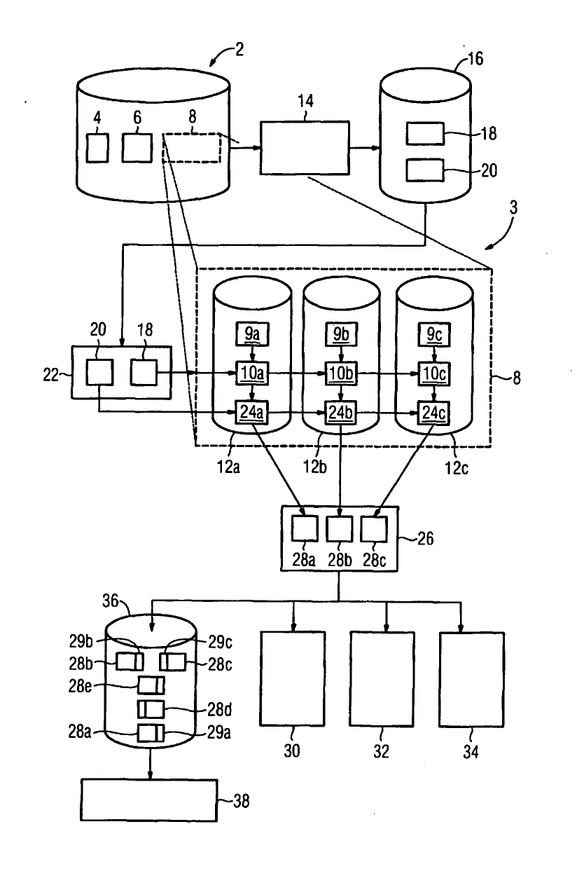

FIG. 1 is based on the example of a one-year clinical trial 3, during which, inter alia, the blood pressure value of patients is determined. The trial is being conducted simultaneously by three investigators or study sites in the USA. The three investigators are a clinic 12a in New York's Bronx, a clinic 12b in Florida and a clinic 12c in Beverly Hills, Los Angeles. The same inclusion/exclusion criteria for registering patients for the trial apply to all three investigators, that is to say clinics 12a-c. In the opinion of a committee of experts entrusted with the design of the trial, the patient collectives 9a-c, comprising in each case the patients recruited or registered by the respective clinics 12a-c, in the selected clinics 12a-c are comparable with respect to the blood pressure values that can be expected. For this purpose, the committee of experts attempted to take account of all factors influencing the blood pressure value of patients in the inclusion/exclusion criteria.

The comparability of the blood pressure values is of crucial importance for the trial 3. For this reason, standardized conditions are prescribed for measuring the blood pressure in the study protocol. In addition, quality control is to be carried out on the blood pressure data collected.

Before the trial commences, the committee of experts therefore specifies that, in the method for quality control, in each case the mean value of all blood pressure values of a data record 10a-c is defined as the quality control parameter for the data records 10a-c which are determined and which contain the blood pressure values of the patients. As comparison criterion, it is specified that the mean values may not deviate from one another by more than 5%.

The quality control method illustrated in FIG. 1 is performed one month following the start of the clinical trial in order to take stock and to decide on the basis of the blood pressure values whether all three clinics 12a-c are supplying data of sufficiently good quality. The financer of the trial, a pharmaceutical firm, has agreed success-based payment with the clinics 12a-c on conclusion of the data collection.

FIG. 1 shows a study database 2 associated with the trial 3, in which the “mean value” 4 is stored as quality control parameter and the value 5% of the tolerance limit 6 is stored as comparison criterion. Also stored in the study database 2 is all the blood pressure data 8 recorded during the first four weeks of the trial, which is represented in FIG. 1 further enlarged with a dotted outline. The blood pressure data 8 is therefore divided between the three data records 10a-c associated with the three clinics 12a-c, since it was collected in their respective patient collectives 9a-c.

In a start step 14, the information that the “mean value” 4 is to be used as the quality control parameter for the quality control to be carried out, and that the tolerance limit 6 of 5% is to be used as comparison criterion, is drawn from the study database 2. Following this, two methods—“mean value formation” 18 and “percentage comparison” 20—are then selected as suitable methods from a database 16 containing a plurality of mathematical/statistical evaluation methods available for quality control.

In an evaluation step 22, first of all the mean value formation 18 is applied to one of the data records 10a-c in each case, and from this the respective quality control parameter, that is to say the mean value 24a-c, is determined from all the blood pressure values of the data records 10a-c. All mean values 24a-c are then compared with one another by way of the percentage comparison 20: the results show that the variance between the mean values 24b and 24c is about 3% and the mean value 24a is about 12% or 15% higher respectively than the two other mean values 24b,c.

Since the mean value 24a varies more than the tolerance limit 6 of 5% from the mean values 24b,c, in a further evaluation step 26 the results determined so far are discussed by the committee of experts tasked with the clinical trial and the following investigation of causes is carried out.

It is assumed that the clinics 12b,c supply high-quality data and that the clinic 12a supplies lower-quality data. First of all the blood pressure measurement devices in the clinics 12a-c are examined and their calibration is checked. The calibration is OK, so consequently cannot lead to incorrect values.

As the next step the measuring methods are checked, during which all the project managers at the study sites 12a-c tasked with running the trials confirm that the blood pressure cuff was applied correctly in each case and the measurements were determined on patients not after physical exertion, but after the prescribed minimum rest period of 10 minutes.

The committee of experts eventually determines the following: The catchment area of study site 12a, i.e. New York's Bronx, covers patients from a significantly lower social class than is the case for the two other study sites 12b and 12c. The underlying disease diabetes, which leads to high blood pressure and is found more frequently in less well-off population groups, is encountered much more frequently in the catchment area of clinic 12a. The study protocol of the clinical trial does in fact prescribe that only patients without diabetes may participate in the trial. The patient collective 9a of clinic 12a should however be checked more closely.

A detailed check of patient files of patient collective 9a reveals that in clinic 12a 40% of the patients registered for the trial 3 have diabetes and have thus been erroneously registered.

A further data analysis of the data record 10a excluding the data of all diabetes patients produces, by way of the mean value formation 18, a new mean value 24a, which likewise varies only by 2% and 1% from the mean values 24b, c. Since all three mean values 24a-c now lie within the tolerance limit 6, the committee of experts assumes that the trial 3 can now be run correctly, since the patient collectives of the study sites 12a-c have now been shown to be actually comparable. The committee of experts entrusted with the design of the trial had not taken the link between social class, diabetes and high blood pressure into account when designing the original trial.

The results of the percentage comparison 22 (12%, 3%, 3%) between the originally determined mean values 24a-c are assigned to the clinics 12a-c as quality criteria 28a-c. The following actions are triggered depending on the quality criteria 28a-c: Due to the variance of 12% (quality criterion 28a), payment 30 for clinic 12a is reduced to 88% of the originally agreed price. This amount is also further reduced to 60%, since 40% of trial participants registered were ones whose data cannot be used.

Owing to the variances of 3% in each case, that is to say within the tolerance limit 6 of 5%, the full payment is made to the two clinics 12b,c. As a result of in each case 2% registered unsuitable participants (subsequently verified percentage of diabetics), a payment of 98% is finally made.

In the data selection 32, only the data records whose associated participants did not have diabetes were finally transferred into the study database 2 from all three data records 10a-c. The rest of the data is excluded from evaluation of the trial.

Since the clinical trial 3 is to be repeated in the following year, in a modification step 34 the study protocol is altered to incorporate the additional inclusion criterion that patients should belong to a better-off social class.

In a ranking database 36, in addition the clinics 12b,c are ranked at the top as extremely reliable investigators with their quality criteria 28b,c of 97% (100-3%). The investigator 12a is stored with its quality criterion 28a of 88% (100-12%) at the bottom end of the list. It thus ranks far lower than other investigators whose quality criteria 28d, e were determined in earlier trials and are higher. In addition, a description 29a-c is assigned to each quality criterion 28a-c, which description contains the exact determination of the quality criteria 28a-c, the structure, composition, characteristics etc. of the respective patient collectives 9a-c.

In a selection step 38 for the clinical trial 3 to be run again next year, the three investigators 28b,c,e are selected, as these were assessed to be the most reliable. The investigators 28a,d are no longer selected for the following trial.

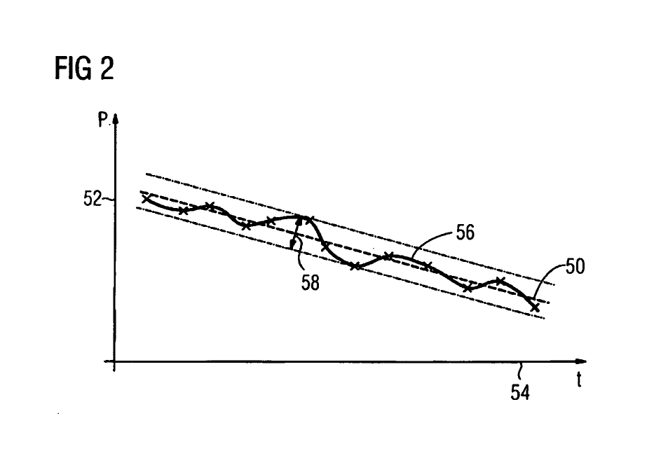

Alternatively, in the above method it would also be possible to perform the following check instead of the mean value formation, with the procedure being otherwise the same: If during the course of trial 3 patients are given a preparation that lowers blood pressure, it can be expected that the blood pressure curve of an individual patient (daily measurement of blood pressure value) will fall steadily. A certain scatter (noise) of the measured values is nevertheless to be expected. FIG. 2 shows the ideally expected curve 50 of blood pressure P 52 over the time t 54 of the trial duration for an individual patient. The actual curve 56 of the blood pressure measured on the patient exhibits a scatter 58 about the ideal curve 50.

The mean value of all scattering 58 of all patients in the patient collectives 9a-c averaged across large patient collectives should again be the same for all comparable patient collectives 9a-c. If a scatter is determined with the above method which is significantly greater than the average scatter for all other patient collectives, then this indicates a systematic measurement error.

If, on the other hand, the scatter of a patient collective is significantly less than for all others, this indicates “too smooth” blood pressure curves, and thus also measurement errors or even falsified ones, that is to say invented measured values.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for carrying out quality control of medical data records collected from different but comparable patient collectives during a medical project, the method comprising:
determining a quality control parameter assigned to each medical data record in a similars manner; and
evaluating the quality control parameters on a basis of comparison criteria.

2. The method as claimed in claim 1, further comprising:
determining, from the quality control parameter assigned to a medical data record, a quality level for every medical data record on a basis of quality criteria.

3. The method as claimed in claim 2, further comprising:
specifying boundary values, assigned to the medical project, for the quality control parameters , wherein
the quality level of the medical data records is determined on the basis of the boundary values.

4. The method as claimed in claims 2, wherein:
the medical data records are collected by project managers, and wherein
the quality levels assigned to the medical data records are assigned to the project managers.

5. The method as claimed in claim 4, wherein
the project managers are remunerated for running the project in accordance with the quality levels assigned to them.

6. The method as claimed in claim 4, wherein
the project managers are entered in a ranking database in accordance with the quality levels assigned to them.

7. The method as claimed in claim 2, wherein
the quality levels assigned to the medical data records are stored in a database, and wherein,
together with each quality level, a description associated with it is stored in the database.

8. The method as claimed in claim 7, wherein
data characterizing the patient collective assigned to the quality level are stored as a description in the database.

9. The method as claimed in
claim 1, wherein the medical data records are determined in the course of a clinical workflow, and wherein
an electronic workflow management system controls the clinical workflow depending on the quality control parameters determined.

10. The method as claimed claim 1, wherein
the procedural rules for at least one of a current and a future medical project is specified depending on the quality control parameters determined.

11. The method as claimed in claim 1, wherein
quality control parameters, comparison criteria and evaluation methods assigned thereto for different medical projects are stored as objects in a toolset, and wherein
for quality control of a particular medical project , suitable objects are selected from the toolset and used.

12. The method as claimed in claim 3, wherein:
the medical data records are collected by project managers, and wherein the quality levels assigned to the medical data records are assigned to the project managers.

13. The method as claimed in claim 12, wherein the project managers are remunerated for running the project in accordance with the quality levels assigned to them.

14. The method as claimed in claim 12, wherein the project managers are entered in a ranking database in accordance with the quality levels assigned to them.

15. The method as claimed in claim 4, wherein the quality levels assigned to the medical data records are stored in a database, and wherein, together with each quality level, a description associated with it is stored in the database.

16. The method as claimed in claim 6, wherein the quality levels assigned to the medical data records are stored in a database, and wherein, together with each quality level, a description associated with it is stored in the database.

17. The method as claimed in claim 12, wherein the quality levels assigned to the medical data records are stored in a database, and wherein, together with each quality level, a description associated with it is stored in the database.

18. The method as claimed in claim 2, wherein the medical data records are determined in the course of a clinical workflow, and wherein an electronic workflow management system controls the clinical workflow depending on the quality control parameters determined.

19. The method as claimed in claim 2, wherein the procedural rules for at least one of a current and a future medical project is specified depending on the quality control parameters determined.

20. The method as claimed in claim 2, wherein quality control parameters, comparison criteria and evaluation methods assigned thereto for different medical projects are stored as objects in a toolset, and wherein for quality control of a particular medical project, suitable objects are selected from the toolset and used.
